(19) United States
(12) Patent Application Publication
(10) Pub. No.: US 2025/0058435 A1
(43) Pub. Date: Feb. 20, 2025

(54) Mechanical Percussion Mechanism

(71) Applicant: Robert Bosch GmbH, Stuttgart (DE)

(72) Inventors: Rainer Britz, Schorndorf (DE); Tobias Herr, Grafenau (DE)

(21) Appl. No.: 18/806,353

(22) Filed: Aug. 15, 2024

(30) Foreign Application Priority Data
Aug. 18, 2023 (DE) 10 2023 207 941.0

(51) Int. Cl. B25B 21/02

(52) U.S. Cl. CPC B25B 21/02

(57) ABSTRACT

A mechanical percussion mechanism for a striking drive of an insertion tool of a handheld power tool includes a rotatably supported intermediate shaft, an impact body, and a rotatably supported output shaft. The intermediate shaft and the impact body each include at least one guide groove for guiding at least one guide body. A guide surface of the guide groove of the intermediate shaft and/or a guide surface of the guide groove of the impact body is configured as a kink-free and/or edge-free surface.

This application claims priority under 35 U.S.C. § 119 to patent application no. DE 10 2023 207 941.0, filed on Aug. 18, 2023 in Germany, the disclosure of which is incorporated herein by reference in its entirety.

The present disclosure relates to a mechanical percussion mechanism for a handheld power tool, in particular a rotary impact screwdriver.

### BACKGROUND

Mechanical percussion mechanisms for rotary impact screwdrivers are known from the prior art. A known problem of these percussion mechanisms, however, is a high mechanical load on the components of the percussion mechanism.

It is a task to provide an improved mechanical percussion mechanism for a handheld power tool.

The object is achieved by the percussion mechanism set forth below. Advantageous embodiments are contained in the subject matter also set forth below.

### SUMMARY

According to one aspect, a mechanical percussion mechanism for a striking drive of an insertion tool of a handheld power tool is provided, comprising a rotatably supported intermediate shaft, an impact body and a rotatably supported output shaft, wherein the intermediate shaft and the impact body each comprise at least one guide groove for guiding at least one guide body, and wherein a guide surface of the guide groove of the intermediate shaft and/or a guide surface of the guide groove of the impact body is configured as a kink-free and/or edge-free surface.

This has the technical advantage that an improved percussion mechanism can be provided. The guide bodies can be guided in the guide grooves with lower energy losses by the kink-free and/or edge-free guide surfaces of the guide grooves. Furthermore, wear on the guide grooves and the guide body may be reduced.

In the sense of the application, guide grooves are the segments of the grooves that define the coupling of the axial displacement with the relative rotation between the impact body and the intermediate shaft in the work area.

A guide surface of a guide groove is an inner surface of the respective guide groove in the sense of the application. When guiding the guide body in the guide groove, the guide body is arranged in the guide groove and rests on the guide surface of the guide groove. The guide surface is formed by the recess of the guide groove and describes the part of the recess on which the guide body rests.

Kink-free or edge-free in the sense of the application means that no kinks or edges are formed within the guide surfaces. In particular, no edges or kinks are formed in the guide surfaces that cross the guide tracks of the guide bodies when they are guided in the guide grooves.

The impact body is also called an impact hammer or a rotary impact hammer in the prior art.

According to one embodiment, the guide groove of the intermediate shaft and/or the impact body has a substantially parabolic path.

The technical advantage of this is that the parabolic path of the guide grooves allows the guide bodies to be guided in the most energy-optimized way possible.

The path of the guide groove relates to a longitudinal direction of the guide groove. The path of the guide groove defines the guide path executed by the guide body when guiding the guide body through the guide groove. The path is substantially parabolic. This means that a deviation from the exact parabolic shape is possible.

According to one embodiment, a circumferential line of the guide groove of the intermediate shaft and/or the impact body is formed as a kink-free circumferential line.

The technical advantage can thereby be achieved that the guide surfaces are configured as smooth and kink-free or edge-free guide surfaces.

The circumferential line of the guide groove describes an outer edge of the recess by which the guide groove is defined.

According to one embodiment, the circumferential line and/or the guide surface of the guide groove of the intermediate shaft and/or the impact body can be depicted by a continuously differentiable function.

This may achieve the technical advantage that optimal kink-free and edge-free guide surfaces of the guide grooves can be generated.

A continuously differentiable function is a mathematical function that is differentiable in a predetermined range and whose derivative is a continuous function in the predefined range.

According to one embodiment, the function is continuously differentiable twice.

This may achieve the technical advantage that optimal kink-free and edge-free guide surfaces of the guide grooves can be generated.

According to one embodiment, a curvature of the guide groove is smaller than a curvature of the guide body.

The technical advantage can thereby be achieved that the guide bodies can be guided in the guide grooves with the minimum possible friction.

The curvature of the guide groove is a curvature of the recess of the guide groove perpendicular to the path of the guide groove.

According to one embodiment, the guide body is configured as a ball.

The technical advantage can thereby be achieved that the guide bodies can be guided in the guide grooves with the minimum possible friction.

According to one embodiment, the axial movement of the impact body along the path of the guide groove is continuous and non-linear to a relative angle between the impact body and the intermediate shaft.

The technical advantage can thereby be achieved that the guide bodies are guided in the guide grooves as energy-efficiently as possible, whereby the energy losses from guiding the guide bodies within the guide grooves are minimized.

The terms continuous and non-linear are to be understood mathematically. The path of the guide groove is thus a path of a mathematical continuous and non-linear function.

The relative angle describes an angle of a relative rotation of the intermediate shaft and the impact body relative to each other.

The impact body does not perform a purely axial movement, but always also has a rotational movement. This refers to the axial portion of the screw movement performed by the impact body.

According to one embodiment, the path of the guide groove of the intermediate shaft and/or the impact body is mirrored at a reversing point.

This has the technical advantage that the symmetric shape of the guide grooves ensures symmetrical guidance of the guide bodies in the guide grooves. The symmetrical guidance is in turn energy efficient with minimized energy losses.

The reversing point is thereby formed by an apex of the substantially parabolic path.

According to one embodiment, the lengths of the guide grooves of the intermediate shaft and the impact body are identical or different.

The technical advantage of this is that the guide grooves are adapted as per requirements. The lengths can be adapted to the radii of the intermediate shaft and the impact body, so that the guide bodies can be guided as uniformly as possible in the guide grooves.

The length of a guide groove runs between the end points of the guide groove. The length runs along the path of the guide groove. The end points are each defined by the circumferential line of the guide groove.

According to one embodiment, slopes of the paths of the guide grooves of the intermediate shaft and the impact body are identical to one another or are different from one another.

This can achieve the technical advantage that the paths of the guide grooves can be adapted to the configurations of the intermediate shaft and the impact body, for example to the radii of the intermediate shaft and the impact body, in order to achieve the most energy-efficient guidance of the guide bodies in the guide grooves.

A slope is a mathematical slope of a mathematical function in the sense of the application.

According to one embodiment, the slopes of the paths of the guide grooves of the intermediate shaft and the impact body are constant or variable.

This can achieve the technical advantage that the paths of the guide grooves can be adapted to the configurations of the intermediate shaft and the impact body, for example to the radii of the intermediate shaft and the impact body, in order to achieve the most energy-efficient guidance of the guide bodies in the guide grooves.

A constant slope is the slope of a linear mathematical function. A variable slope is a non-constant slope of a non-linear function.

According to one embodiment, the percussion mechanism is configured as a rotary impact mechanism.

This has the technical advantage that an improved rotary impact mechanism can be provided.

According to one aspect, a handheld power tool having a mechanical percussion mechanism according to any one of the preceding embodiments is provided.

This can achieve the technical advantage of providing an improved handheld power tool with an improved percussion mechanism with the technical advantages described above.

According to one embodiment, the handheld power tool is configured as a rotary impact screwdriver.

This has the technical advantage that an improved rotary impact screwdriver can be provided.

### BRIEF DESCRIPTION OF THE DRAWINGS

Embodiments of the disclosure are described with reference to the following figures. The figures show:

FIG. 1 a schematic illustration of a handheld power tool having a mechanical percussion mechanism according to one embodiment;

FIG. 2 a schematic illustration of a mechanical percussion mechanism for a handheld power tool according to one embodiment;

FIG. 3 a schematic illustration of an intermediate shaft of the mechanical percussion mechanism according to one embodiment;

FIG. 4 a schematic illustration of an impact body of the percussion mechanism according to one embodiment;

FIG. 5 a further schematic illustration of the impact body of the percussion mechanism according to one embodiment;

FIG. 6 a schematic illustration of a guide groove of an intermediate shaft and/or an impact body of a percussion mechanism of the prior art; and

FIGS. 7-9 graphic diagrams of a winding and impact behavior of a percussion mechanism of the prior art and the percussion mechanism according to the disclosure.

### DETAILED DESCRIPTION

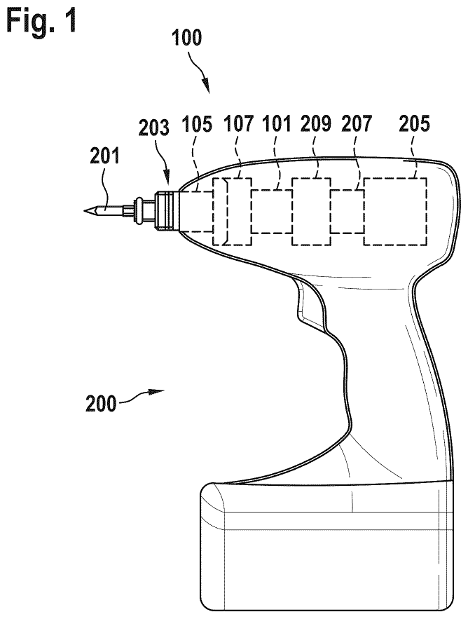

FIG. 1 shows a schematic illustration of a handheld power tool 200 having a mechanical percussion mechanism 100 according to one embodiment.

In the embodiment shown, the handheld power tool comprises a drive motor 205, a motor shaft 207, a gear unit 209, a tool holder 203 having an insertion tool 201. The handheld power tool further comprises a percussion mechanism 100 according to the present disclosure having an intermediate shaft 101, an output shaft 105, and an impact body 103. The percussion mechanism 100 is arranged between the gear unit 209 and the tool holder 203. The percussion mechanism 100 can be rotated via the gear unit 209 by the drive motor 205, wherein the insertion tool 201 arranged in the tool holder 203 can be driven in a rotatable manner via the rotation of the percussion mechanism 100. The tool holder may be an internal receptacle and/or an external receptacle.

According to one embodiment, the percussion mechanism 100 is configured as a rotary impact mechanism. The handheld power tool 200 is correspondingly configured as a rotary impact screwdriver.

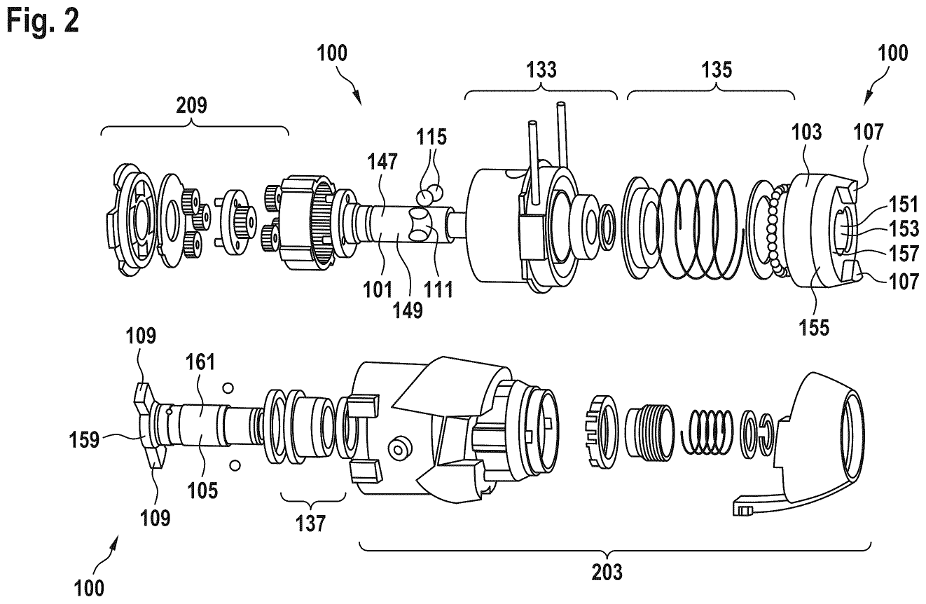

FIG. 2 shows a schematic illustration of a mechanical percussion mechanism 100 for a handheld power tool 200 according to one embodiment.

FIG. 2 schematically illustrates an interaction of the percussion mechanism 100 with the gear unit 209 and the tool holder 203 of the handheld power tool 200 of FIG. 1.

In the embodiment shown, the percussion mechanism 100 comprises the intermediate shaft 101. The intermediate shaft 101 comprises a cylindrical body 149. At least one guide groove 111 is configured on an outer surface 147 of the cylinder body 149. Spherical guide bodies 115 can be slidably arranged in the guide groove 111.

The percussion mechanism 100 further comprises an impact body 103. The impact body 103 comprises a ring body 155 with an axial passage opening 153. Two drive cams 107 are configured on an end face 157 of the ring body 155.

The percussion mechanism 100 further comprises an output shaft 105. The output shaft 105 comprises a cylinder body 161 and a base element 159 configured at a free end of the cylinder body 161. Two output cams 109 are configured on the base element 159.

In the prior art, the output shaft 105 with the output cams 109 is also called an anvil. The impact body 103 with drive cams 107 is referred to as a hammer. During impact operation, the drive cams 107 of the hammer 103 thus strike the output cams 109 of the anvil 105.

In the embodiment shown, the percussion mechanism further comprises a bearing unit 133 and a spring element 135.

The intermediate shaft 101 can be coupled to the gear unit 209 via corresponding gearwheels. The cylindrical body 149 of the intermediate shaft 101 can be passed through the bearing unit 133 and the spring element member 135 through the passage opening 153 of the impact body 103.

According to the present disclosure, at least one guide groove 113, not shown in FIG. 2, is configured on an inner surface 151 of the passage opening 153 of the impact body 103. In the guide groove 113, the guide bodies 115 can be arranged rotatably. When the intermediate shaft 101 passes through the passage opening 153 of the impact body 103, the intermediate shaft 101 can be rotatably coupled to the output shaft 105. The output shaft 105 can be inserted rotatably into the tool holder 203.

During impact operation of the handheld power tool 200, the intermediate shaft 101 pulls up the impact body 103. The impact body 103 moves axially in the direction of the intermediate shaft 101 and rotates around the circumferential direction towards the intermediate shaft 101. When pulled up, the impact body 103 thus rotates at a slightly changed speed in relation to the intermediate shaft 101 and performs an axial movement. When the impact body 103 is pulled up, the impact body 103 performs a rotary impact movement in which the impact body 103 is moved axially and in the circumferential direction. The impact body 103 is moved towards the tool holder 203 and performs a rotary movement along the circumferential direction. The drive cams 107 of the impact body 103 strike the output cam 109 of the output shaft 105, causing the output shaft 105 to rotate by impact. This causes the impact operation of the handheld power tool 200 by also causing the insertion tool 201 to rotate by impact.

In the embodiment shown, the percussion mechanism 100 further comprises a further bearing unit 137 arranged between the output shaft 105 and the tool holder 203.

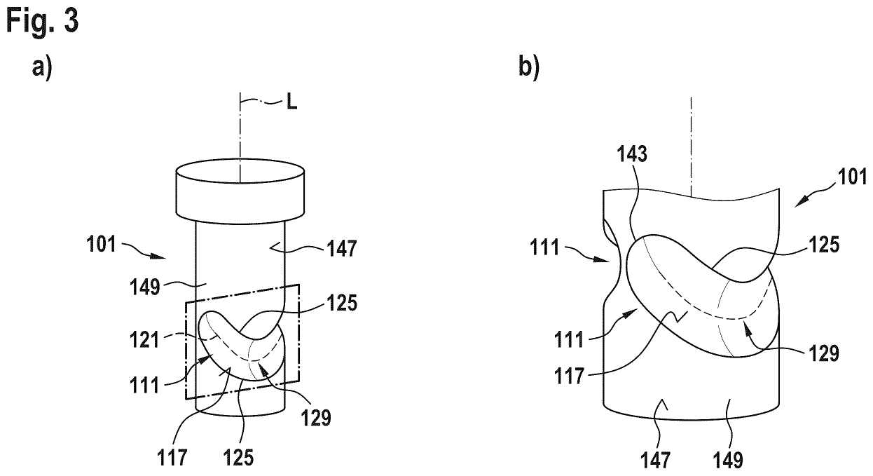

FIG. 3 shows a schematic illustration of an intermediate shaft 101 of the mechanical percussion mechanism 100 according to one embodiment.

According to the disclosure, the intermediate shaft 101 comprises at least one guide groove 111 for guiding at least one guide body 115. The guide groove 111 has a guide surface 117. The guide surface is formed by an inner surface of the recess through which the guide groove 111 is formed. According to the present disclosure, the guide surface 117 of the guide groove 111 of the intermediate shaft 101 is configured as a kink-free and/or edge-free surface.

In the embodiment shown, the guide groove 111 has a substantially parabolic path 121. The path 121 describes a line shape that runs along a longitudinal direction of the guide groove 111. The path 121 lies within the cylinder body 149 of the intermediate shaft 101. This can be seen in graph b). The path 121 extends at a lowest point of the recess of the guide groove 111.

The kink-free or edge-free guide surface 117 has no edges or kinks in accordance with graphs a) and b) that intersect the drawn path 121 of the guide surface 117.

In the embodiment shown, the guide groove 111 further comprises a circumferential line 125. The circumferential line 125 describes an outer edge of the recess through which the guide groove 111 is formed. In the embodiment shown, the circumferential line 125 of the guide groove 111 is configured as a kink-free circumferential line 125. As shown in graphs a) and b), the circumferential line 125 has no kinks. Rather, the circumferential line 125 may be represented by a continuously differentiable mathematical function that is continuously differentiable at any point along the circumferential line 125.

The same applies to the guide surface 117. As the guide surface 117 also has no kinks or edges at any point, the guide surface 117 can be represented by a two-dimensional mathematical function that is continuously differentiable at any point in its definition range.

According to one embodiment, the mathematical functions by which the circumferential line 125 or the guide surface 117 of the guiding groove 111 are represented are continuously differentiable at least twice.

According to one embodiment, a curvature of the guide groove 111 is smaller than a curvature of the spherical guide body 115. Due to the smaller curvature of the guide groove 111, the guide body 115, not shown in FIG. 3, is slidably arranged in the guide groove 111.

In the embodiment shown, the path 121 of the guide surface 117 or the guide groove 111 is mirrored at a reversing point 129. The reversing point 129 is arranged in a lowest point of the recess of the guide groove 111 on the guide surface 117 and describes an apex of the guide groove 111, which is configured as a substantially parabolic shape.

Due to the substantially parabolic shape of the path 121 of the guide groove 111, the slope of the path 121 can be changed and is thus not constant.

Graph b) depicts an enlarged representation of the intermediate shaft 101 of graph a), wherein in graph b), the intermediate shaft is rotated about a longitudinal axis L of the intermediate shaft 101. As indicated in graph b), the intermediate shaft 101 comprises two guide grooves 111, each formed on the outer surface 147 of the cylinder body 149.

According to one embodiment, the two guide grooves 111 of the intermediate shaft 101 are configured identically.

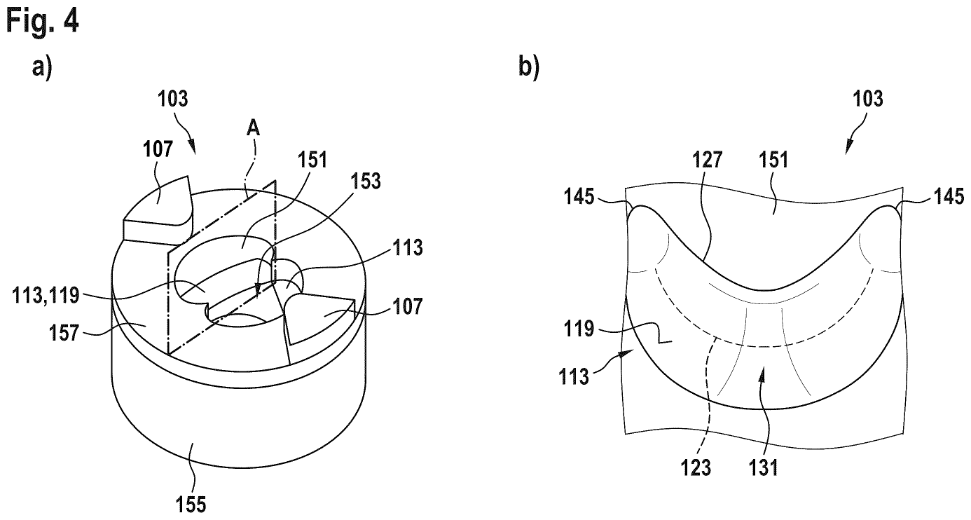

FIG. 4 shows a schematic representation of an impact body 103 of the percussion mechanism 100 according to one embodiment.

Graph b) shows an enlarged representation of the guide groove 113 formed on the inner surface 151 of the passage opening 153 of the ring body 155 of the impact body 103. The plot shown in graph b) shows the guide groove 113 along the sectional plane A in graph a).

According to the disclosure, the guide groove 113 comprises a guide surface 119, which is configured as a kink-free or edge-free surface. Analogously to the guide surface 117 of the guide groove 111 of the intermediate shaft 101, the guide surface 119 in the embodiment shown has a substantially parabolic path 123. The path 123 lies within the ring body 155 of the impact body 103.

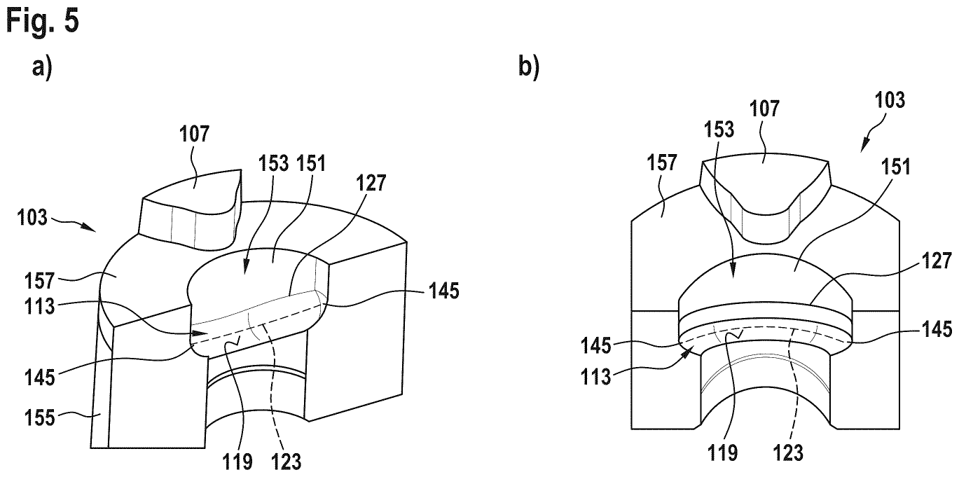

This is indicated in graph b) and in FIG. 5 b). The path 123 extends at a lowest point of the recess of the guide groove 111. The guide surface 119 has no edges or kinks that cross the path 123.

In the embodiment shown, the guide groove 113 further comprises a circumferential line 127. The circumferential line 127 is also kink-free.

In the embodiment shown, the guide surface 119 and the circumferential line 127 of the guide groove 113 can each be represented with continuously differentiable mathematical functions.

According to one embodiment, the continuously differentiable mathematical functions are constantly differentiable at least twice at each point of their definition range.

According to one embodiment, a curvature of the guide groove 113 of the impact body 103 is smaller than a curvature of the spherically formed guide bodies 115.

Analogously to the guide groove 111 of the intermediate shaft 101, the path 123 of the guide groove 113 of the impact body 103 is mirrored at a reversing point 131. The reversing point 131 is arranged in a lowest point of the recess of the guide groove 113 on the guide surface 119 and describes an apex of the guide groove 113, which is configured as a substantially parabolic shape.

The guide grooves 111 of the intermediate shaft 101 and the guide grooves 113 of the impact body 103 can each be of the same design. In this case, the guide grooves 111, 113 can have identical lengths. The length of a guide groove 111, 113 runs along the path 121, 123 between end points 143, 145. Endpoints 143, 145 of the guide grooves 111, 113 represent the ends of the respective guide grooves 111, 113. The guide groove 111 of the intermediate shaft 101 has two end points 143 and the intermediate shaft 113 of the impact body 103 analogously has two end points 145. The guide bodies 115 can be guided in the guide grooves 111, 113 at a maximum between the end points 143, 145. Furthermore, the paths 121, 123 of the guide grooves 111, 113 may have the same slopes.

In the embodiment shown, the slope of the path 123 is variable, i.e., not constant, due to the substantially parabolic path 123.

As indicated in graph a), the impact body 103 comprises two guide grooves 113, each of which is arranged on the inner surface 151 of the passage opening 153 of the ring body 155. When the intermediate shaft 101 is inserted through the passage opening 153, each spherical guide body 115 is guided through a guide groove 111 of the intermediate shaft 101 and a guide groove 113 of the impact body 103. By guiding the spherical guide bodies 115 in the substantially parabolic guide grooves 111, 113, the intermediate shaft 101 and the impact body 103 can be rotated relative to each other about the longitudinal axis L and can be displaced along the longitudinal axis L.

According to one embodiment, the guide groove 113 has a smaller curvature than the spherical guide bodies 115. The spherical guide body 115 can thereby slide or roll in the guide groove 113 of the impact body 103.

According to one embodiment, the axial movement of the impact body 103 along the path 123 of the guide groove 113 is continuous and non-linear to a relative angle α between that of the intermediate shaft 101 and the impact body 103. The relative angle α describes a relative rotation of the intermediate shaft 101 relative to the impact body 103.

FIG. 5 shows another schematic representation of the impact body 103 of the percussion mechanism 100 according to one embodiment.

Graphs a) and b) show sectional views of the impact body 103 of FIG. 4. The guide grooves 113 are each recessed into the inner surfaces 151 of the passage opening 153.

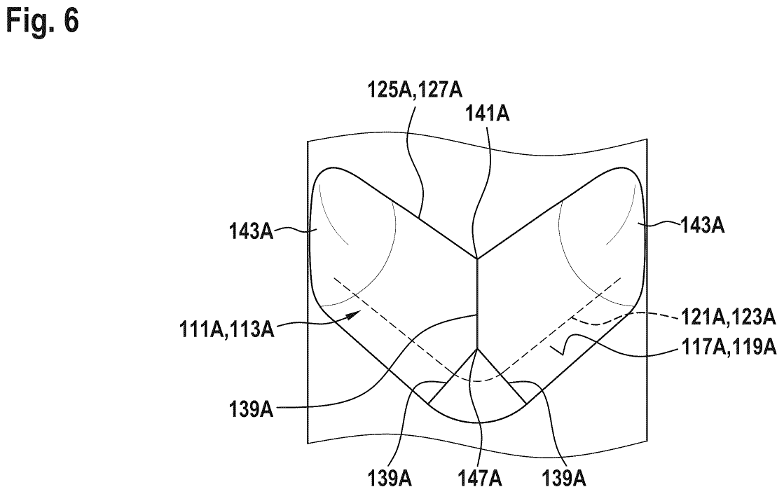

FIG. 6 shows a schematic illustration of a guide groove 101A of an intermediate shaft 101A and/or an impact body 103A of a percussion mechanism of the prior art.

From the prior art, guide grooves 111A, 113A, which are formed both in intermediate shafts and impact bodies of the percussion systems known from the prior art, are provided with guide surfaces 117A, 119A, which are not kink-free or edge-free. Instead, the guide grooves 111A, 113A shown in FIG. 6, which are representative of guide grooves known from the prior art, have three edges 139A meeting at an inflection point 147A.

The edges 139A are formed in the guide surface 117A, 119A and cross the path 121A, 123A of the guide groove 111A, 113A. Due to the edges 139A, the guide surface 117A, 119A cannot be represented by a continuously differentiable mathematical function, as the mathematical function is not differentiable in the edges 139A. The same applies to the path 121A, 123A, which is also not differentiable at edge 139A.

The circumferential line 125A, 127A of the guide groove 111A, 113A also has a kink 141A, as a result of which the circumferential line 125A, 127A in the prior art cannot be represented by a continuously differentiable mathematical function. Due to the edges 139A of the guide surface 117A, 119A, the guidance of the spherical guide bodies within the guide groove 111A, 113A is not as uniform as it is in the guide grooves 111, 113 of the present disclosure.

Instead, the spherical guide bodies 115 undergo a sudden movement at the level of the edges 139A of the guide surfaces 117A, 119A, as a result of which uniform guidance of the guide bodies 115 is not possible and increased material loading and increased material wear of both the guide bodies 115 and the guide grooves 111A, 113A are caused.

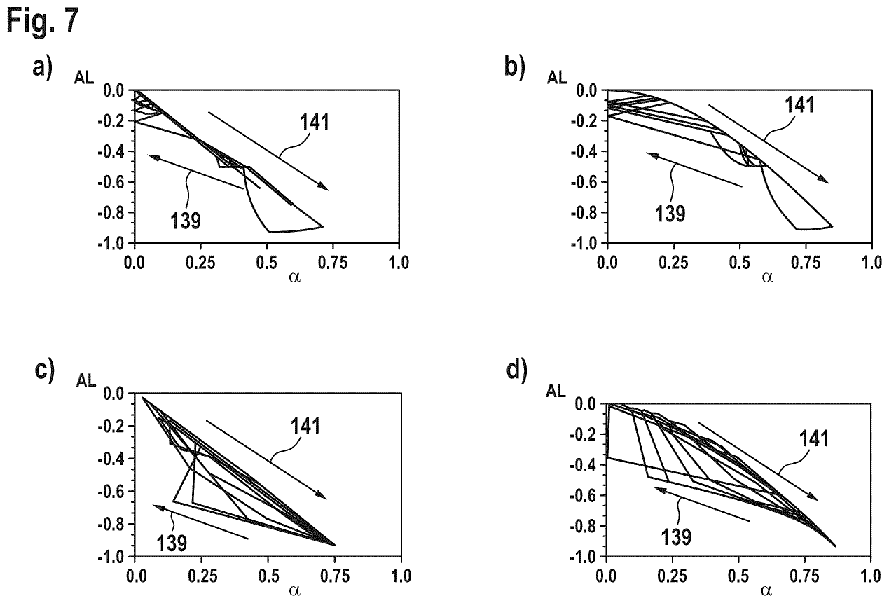

FIGS. 7-9 show graphic diagrams of a pull-up and impact behavior of a percussion mechanism of the prior art and the percussion mechanism 100 according to the disclosure.

In FIG. 7, the graphs a) to d) show axial layers AL of the intermediate shaft 101 and the impact body 103 plotted against the relative angle α between the intermediate shaft 101 and the impact body 103.

In graphs a) and b) this is shown for a start-up phase of the impact operation between 0 and 0.1 seconds. Graphs c) and d) show an impact operation after the start-up phase for 3.6 to 3.7 seconds. The graphs a) and c) show results for percussion mechanisms with guide grooves 111A, 113A known in the prior art and shown in FIG. 6. Graphs b) and d) show results for a percussion mechanism 100 with guide grooves 111, 113 according to the disclosure.

Graphs a) to d) show curves for the pull-up 141 and impact 139 between the output shaft 105 and the impact body 103.

As can be seen from the graphs b) and d), the curves of the graphs b) and d), i.e., the axial position AL in relation to the relative angle α, run in a much more ordered and symmetrical form than the percussion mechanism known from the prior art, as shown in the graphs a) and c).

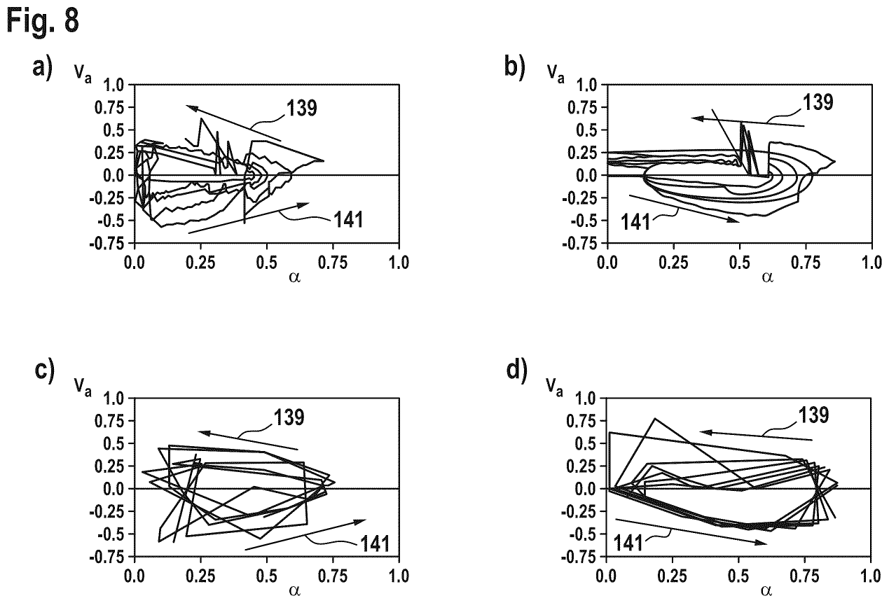

FIG. 8 shows axial velocities Vₐ plotted in graphs a) to d) in relation to the relative angle α between the intermediate shaft 101 and the impact body 103.

Graphs a) and b) again show the start-up phase for times between 0.0 and 0.1 seconds. Graphs c) and d) show results for impact operation after the start-up phase for times between 3.6 and 3.7 seconds.

Graphics a) and c) again show results for a percussion mechanism known from the prior art. Graphs b) and d) show results for the percussion mechanism 100 according to the disclosure.

Graphs a) to d) show curves for the pull-up 141 and impact 139 between the output shaft 105 and the impact body 103.

As can be seen from the graphs b) and d), the axial velocities Vₐ relative to the relative angle α for the percussion mechanism 100 according to the disclosure show a substantially more symmetrical and uniform path than that of the percussion mechanism known from the prior art, as shown in the graphs a) and c).

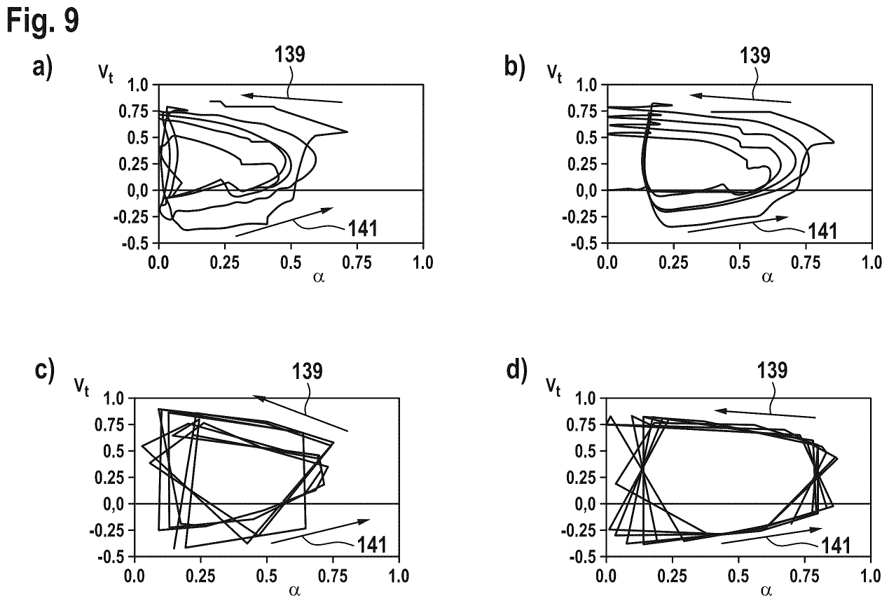

FIG. 9 shows tangential velocities Vₜ plotted in graphs a) to d) in relation to the relative angle α between the intermediate shaft 101 and the impact body 103.

Graphs a) and b) show the tangential velocities Vₜ relative to the relative angle α again for the start-up phase for times between 0.0 and 0.1 seconds.

Graphs a) to d) show curves for the pull-up 141 and impact 139 between the output shaft 105 and the impact body 103.

Graphs c) and d) show tangential velocities Vₜ for impact operation after the start-up phase for times between 3.6 and 3.7 seconds. Graphics a) and c) show results for a percussion mechanism known from the prior art. Graphs b) and d) show results for the percussion mechanism 100 according to the disclosure.

As can be seen from the graphs b) and d), the tangential velocities Vₜ relative to the relative angle α for the percussion mechanism 100 according to the disclosure show a substantially more symmetrical and uniform path than that of the percussion mechanism known from the prior art, as shown in the graphs a) and c).

The simulation or measurement results shown in graphs 7 to 9 illustrate that the guide grooves 111, 113 according to the disclosure with edge-free or kink-free guide surfaces 117, 119 enable a substantially more uniform guidance of the guide body 115 and the impact body 103. This enables a substantially more energy-efficient and material-friendly operation of the percussion mechanism 100 according to the disclosure, in which axial positions AL, tangential velocities Vₜ and axial velocities Vₐ of the intermediate shaft 101 and the impact body 103 can be brought about with substantially more harmonious paths in relation to one another both in the start-up phase and during impact operation.

What is claimed is:

1. A mechanical percussion mechanism for a striking drive of an insertion tool of a handheld power tool, comprising:
a rotatably supported intermediate shaft;
an impact body; and
a rotatably supported output shaft,
wherein the intermediate shaft and the impact body each comprise at least one guide groove configured to guide at least one guide body, and
wherein a guide surface of the guide groove of the intermediate shaft and/or a guide surface of the guide groove of the impact body is configured as a kink-free and/or edge-free surface.

2. A percussion mechanism according to claim 1, wherein the guide groove of the intermediate shaft and/or the impact body has a substantially parabolic path.

3. The percussion mechanism according to claim 1, wherein a circumferential line of the guide groove of the intermediate shaft and/or the impact body is configured as a kink-free circumferential line.

4. The percussion mechanism according to claim 3, wherein the circumferential line and/or the guide surface of the guide groove of the intermediate shaft and/or the impact body is configured to be depicted by a continuously differentiable function.

5. The percussion mechanism according to claim 4, wherein the function is at least continuously differentiable twice.

6. The percussion mechanism according to claim 1, wherein a curvature of the guide groove is smaller than a curvature of the guide body.

7. The percussion mechanism according to claim 1, wherein the guide body is configured as a ball.

8. The percussion mechanism according to claim 2, wherein the axial movement of the impact body along the path of the guide groove is continuous and non-linear to a relative angle between the intermediate shaft and the impact body.

9. The percussion mechanism according to claim 2, wherein the path of the guide groove of the intermediate shaft and/or the impact body is mirrored at a reversing point.

10. The percussion mechanism according to claim 1, wherein the lengths of the guide grooves of the intermediate shaft and the impact body are identical or different.

11. The percussion mechanism according to claim 2, wherein slopes of the paths of the guide grooves of the intermediate shaft and the impact body are identical or different from one another.

12. The percussion mechanism according to claim 2, wherein the slopes of the paths of the guide grooves of the intermediate shaft and the impact body are each constant or changeable.

13. The percussion mechanism according to claim 1, wherein the percussion mechanism is configured as a rotary impact mechanism.

14. A handheld power tool having a mechanical percussion mechanism according to claim 1.

15. The handheld power tool according to claim 14, wherein the handheld power tool is configured as a rotary impact screwdriver.
